(19) United States
(12) Patent Application Publication
(10) Pub. No.: US 2007/0174699 A1
(43) Pub. Date: Jul. 26, 2007

(54) Automated generation of operational monitor platform for computer boards

(75) Inventor: Don V. Clementi, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/325,827

(22) Filed: Jan. 5, 2006

(51) Int. Cl. G06F 11/00

(52) U.S. Cl. 714/25

(57) ABSTRACT

A method of testing a system architecture within a computer board including receiving an input software model, an input system model and an input hardware model at a development computer, retrieving software module information from a software module library, retrieving system module information from a system module, and retrieving hardware module information from a hardware module library. The method further includes generating test software and boot software using the retrieved module information, and deploying the generated test software and the generated boot software to a computer board. The access and usage of the test software and boot software assist in a build process of the computer board, so that hardware components are attached to the computer board according the system architecture.

### BACKGROUND

Typically, as computer boards are designed, the boot monitor and operating system are initially excluded from the design. The operating software design is typically initiated after the hardware design is prototyped and tested. For example, the hardware on the computer board is often tested with an engineer probing the various pins to evaluate the operation of different devices on the board. The engineer makes judgment calls about the optimal order of testing the board components. Also, the engineer makes judgment calls about the device interactions which are critical in the operation of the computer board. After the hardware is optimized, the software is typically implemented. In some cases, commercial operating software solutions are available for testing the prototype computer board, but such solutions can be expensive, inflexible and require target license agreements before deployment.

In some cases, various difficulties or imperfections in the hardware design become apparent when the software is implemented on the board. For example, it may be come apparent that an interaction between two or more components has an unexpected deleterious effect on the operation of the computer board.

However, since the boot monitor and the operating system design are applied later in the development of the computer board, opportunities for improvements in the hardware design, which become apparent with the introduction of the software elements, are lost until a second iteration of the computer board

### SUMMARY

One aspect of the present invention provides a method of testing a system architecture within a computer board. The method includes receiving an input software model, an input system model and an input hardware model at a development computer. The software model identifies software requirements of the system architecture, the hardware model identifies hardware requirements of the system architecture and the system model identifies the system requirements of the system architecture. The method further includes retrieving software module information from a software module library in a record, retrieving system module information from a system module library in a database and retrieving hardware module information from a hardware module library in the database. Test software and boot software are generated using the retrieved software module information, the retrieved system module information and the retrieved hardware module information. The generated test software and the generated boot software are deployed to a computer board, so that the access and usage of the test software and boot software assist in a build process of the computer board, and so that hardware components are attached to the computer board according the system architecture. Operational monitoring software includes the test software and the boot software and is in electrical communication with the hardware system.

Another aspect of the present invention provides a system for building a system architecture on a computer board. The system includes means for creating an operational monitoring software including test software and boot software, means for interfacing an operational monitor database platform to a computer board implementing hardware and software, means for deploying the operational monitoring software to the computer board from the operational monitor database platform and means for testing the computer board by activating the test software.

Another aspect of the present invention provides development software including program instructions embodied on a computer-readable medium. When the development software is executed by a development computer the program instructions are operable to cause the development computer to receive an input software model, an input system model and an input hardware model at a development computer. The software model identifies software requirements of the system architecture, the hardware model identifies hardware requirements of the system architecture and the system model identifies the system requirements of the system architecture. When the development software is executed by a development computer the program instructions are also operable to cause the development computer to retrieve software module information from a software module library in a database, retrieve system module information from a system module library in the database, retrieve hardware module information from a hardware module library in the database and generate test software and boot software using the retrieved software module information, the retrieved system module information and the retrieved hardware module information. When the development software is executed by a development computer the program instructions are also operable to cause the development computer to deploy the generated test software and the generated boot software to a computer board.

Another aspect of the present invention provides system that includes a development computer and a database communicatively coupled to the development computer. The development computer is operable to receive an input software model, an input system model and an input hardware model. The software model identifies software requirements of a system architecture, the hardware model identifies hardware requirements of the system architecture and the system model identifies the system requirements of the system architecture. The development computer is additionally operable to retrieve software module information from a software module library in a database, retrieve system module information from a system module library in the database, and retrieve hardware module information from a hardware module library in the database. The development computer is additionally operable generate test software and boot software using the retrieved software module information, the retrieved system module information and the retrieved hardware module information and to deploy the generated test software and the generated boot software to a computer board so that the access and usage of the test software and boot software assist in a build process of the computer board.

The details of one or more embodiments of the claimed invention are set forth in the accompanying drawings and the description below. Other features and advantages will become apparent from the description, the drawings, and the claims.

### DRAWINGS

FIG. 1 is a block diagram illustrating one exemplary embodiment of an operational monitor environment.

FIG. 2A is a block diagram of one embodiment of a development environment.

FIG. 2B is a block diagram of one embodiment of a database in the development environment of FIG. 2A.

FIG. 3 is a flow diagram of one embodiment of a method of generating an operational monitor.

FIG. 4 is a block diagram of one embodiment of a deployment environment.

FIG. 5 is a block diagram of one embodiment of an upgrade environment.

Like reference numbers and designations in the various drawings indicate like elements.

### DETAILED DESCRIPTION

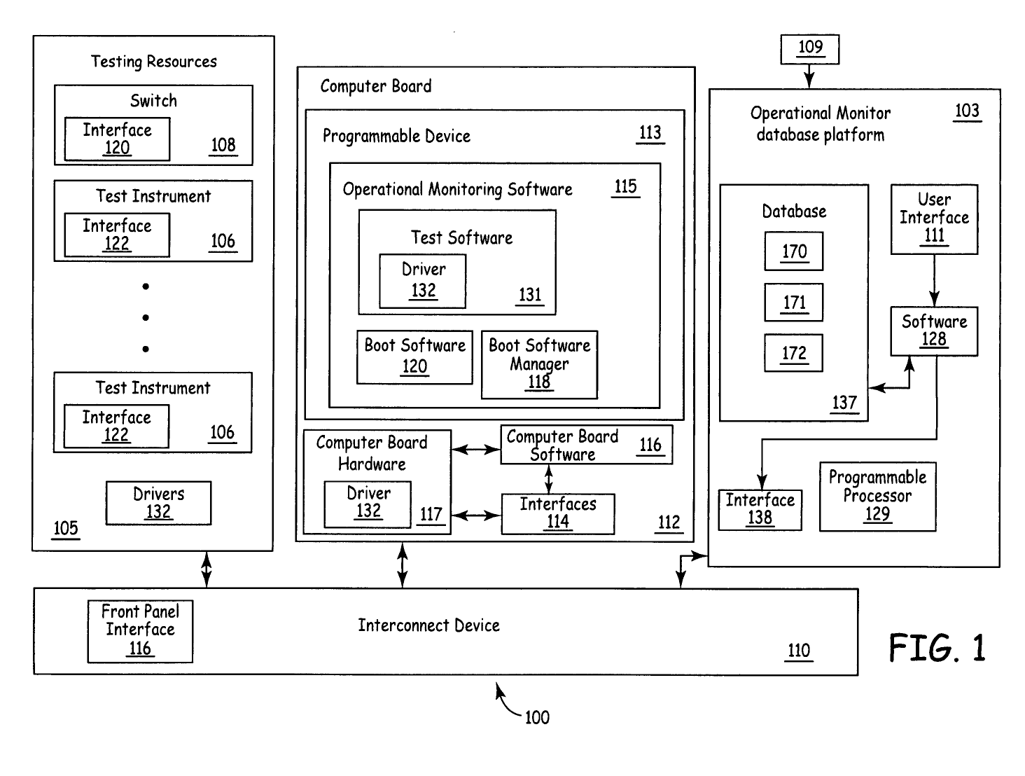

FIG. 1 is a block diagram illustrating one exemplary embodiment of an operational monitor system environment 100. Embodiments of the systems, devices, methods, and techniques described here can be used as, with, in or on embodiments of the operational monitor system environment 100 shown in FIG. 1. In the embodiment shown in FIG. 1, the operational monitoring system environment 100 comprises a computer board (CB) 112, one or more testing resources 105, an operational monitor database platform 103, and a system architecture input 109. As used herein, the term computer board applies to any “intelligent” computer board that includes a processor. The CB 112 comprises an operational monitoring software 115, computer board (CB) hardware 117, computer board (CB) software 116 and interfaces (I/F) 114. The operational monitor database platform 103 receives a system architecture input 109. The system architecture input 109 defines the system configuration for the CB 112 and defines the components, interfaces, interconnects and the timing relative to the CB 112. The operational monitor database platform 103 generates an operational monitoring software 115 specific to the particular CB 112, which is used to boot up and test the components on the CB 112. As used herein the term software applies to software, firmware, or other programming necessary to program a particular programmable device. The operational monitoring software 115 is downloaded onto (or for use by) a programmable device 113, such as a programmable read-only memory (PROM) device, and the programmable device 113 is integrated on the CB 112. In one implementation of the embodiment of FIG. 1, the operational monitoring software 115 is downloaded onto a programmable device 113 that is already integrated on the CB 112. In another implementation of the embodiment of FIG. 1, the operational monitoring software 115 interfaces to the testing resources 105 through interconnect device 110. The operational monitoring software 115 interfaces to the CB hardware 117 and the CB software 116 through the interfaces 114. The CB hardware 117 is also referred to here as “hardware components” 117. The one or more testing resources 105 include, in the embodiment shown in FIG. 1, test instruments 106, a switch 108, and drivers 132. The software 128 and the database 137 are applicable to a plurality of architectures based on a plurality of system architecture input 109. The CB 112 is any board that includes a programmable device (for example, programmable device 113) and which requires software initialization and software test. The CB 112 is typically implemented as a mother board, a back plane, a computer board, and/or a single board computer.

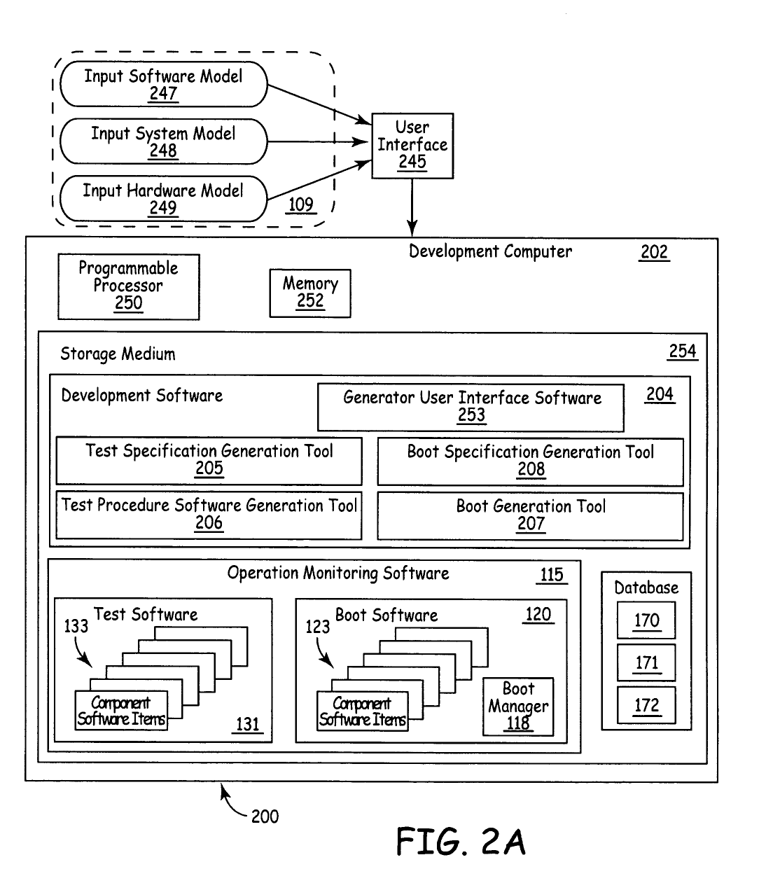

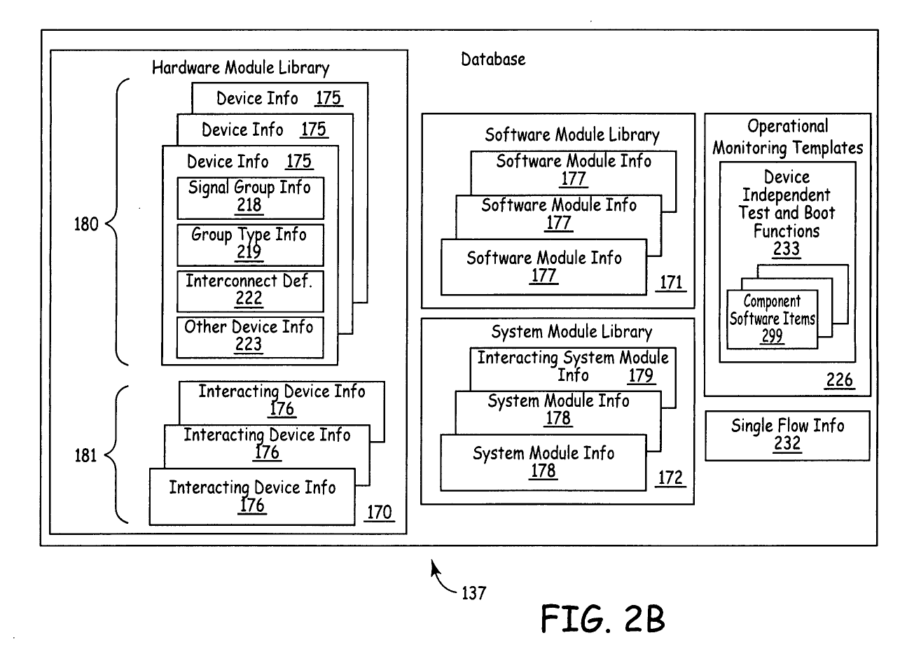

The operational monitor database platform 103 comprises a user interface (I/F) 111, software 128, a database 137, and an interface 138. The operational monitor database platform 103 uses libraries 170-172 in the database 137 to develop the operational monitoring software 115 for the CB 112. The libraries 170-172 are described in detail below with reference to FIGS. 2A and 2B. The software 128 causes the operational monitor database platform 103 to perform at least a portion of the processing described here as being performed by the operational monitor database platform 103. Each of the various items of software 128 comprise program instructions that are stored or otherwise embodied on one or more items of computer-readable media such as a local media (such as a local hard disk drive or removable media such as an optical disk) and/or a shared or remote media (such as a network file server). The software 128 is executed by a programmable processor 129 (or other programmable device) included in the operational monitor database platform 103.

The operational monitor platform 115 is used to start-up or boot the CB 112 and to test the CB hardware 117 and the CB software 116. The programmable device 113 on which the operational monitor database platform 103 is executed is communicatively coupled to the CB 112 using an interconnect device 110. The CB 112 includes one or more interfaces 114 (also referred to here as “CB interfaces” 114) that are communicatively coupled to one or more front panel interfaces 116 included in the interconnect device 110. In the particular exemplary embodiment shown in FIG. 1, the CB 112 and the interconnect device 110 both comprise a single CB interface 114 and front panel interface 116, respectively (though it is to be understood that other numbers of interfaces are used in other embodiments). The front panel interface 116 is selected so as to mate with the CB interfaces 114 of the CB 112 (for example, using a suitable cable). In one implementation of the CB 112, the CB interfaces 114 include pins on an embedded chip and/or conductive lead lines on the CB 112. The test instruments 106 include appropriate instruments for generating stimulus for or recording responses from the CB 112. Examples of such test instruments 106 include one or more signal generators, digital multimeters, waveform analyzers, and power supplies.

The switch 108 is used to route signals between the test instruments 106 and the CB 112 via the interconnect device 110. The switch 108, in the embodiment shown in FIG. 1, is implemented using a crosspoint matrix that is able to selectively couple any of a number of “inputs” to any of a number of “outputs.”

The switch 108 includes an interface 120 (also referred to here as the “switch interface” 120) that is used to communicatively couple the inputs and outputs of the switch 108 to the test instruments 106. In one embodiment, the switch interface 120 of the switch 108 comprises multiple pins (or other terminals). In one implementation of such an embodiment, the switch 108 is implemented using several relay matrix modules. Each of the test instruments 106 include an interface 122 (also referred to here as the “test instrument” interface 122) that is used to communicatively couple the respective test instrument 106 to one or more input pins included in the switch interface 120 of the switch 108. The CB 112 is communicatively coupled to one or more outputs pins included in the switch interface 120 of the switch 108 (via the CB interfaces 114 and front panel interface 116). The switch 108 routes signals between the test instruments 106 and the CB hardware 117 and CB software 116 (via the interconnect device 110). The CB hardware 117 and the CB software 116 are communicatively coupled to interact with each other. In one implementation of the CB hardware 117 and the CB software 116, the CB software 116 is embedded in and executed by a programmable device included in the CB hardware 117.

In the implementation of the embodiment of the operational monitoring software environment 100 illustrated in FIG. 1, the testing resources 105 are located external to the CB 112. In one implementation of the embodiment of the operational monitoring software environment 100, the testing resources 105 are embedded in the CB 112 based on the system architecture or system model. In another implementation of the embodiment of the operational monitoring software environment 100 some of the testing resources are embedded in the CB 112 while others of the testing resources 105 are external to the CB 112. In one implementation of the operational monitor system environment 100 that include external testing resources 105, the testing instruments 105 include at least one display to visually provide an operator of one or more of the test instruments 106 with instructions about how and when to connect a test instrument 106 to the a lead line or pin on the CB hardware 117.

The operational monitoring software 115 is communicatively coupled to the testing resources 105 using one or more buses or point-to-point links (not shown). The operational monitoring software 115 comprises test software 131 and boot software 120 that causes the CB 112 to perform at least a portion of the processing described here as being performed by the CB 112. Each of the various items of boot software 120 and test software 131 described here comprise program instructions that are stored or otherwise embodied on one or more items of computer-readable media such as a local media (such as a local hard disk drive or removable media such as an optical disk) and/or a shared or remote media (such as a network file server) and are executed by the programmable device 113. The boot software 120 is controlled by the boot software manager 118.

The test software 131 interacts with the testing resources 105 in order for various test-related actions to be performed in order to test the CB 112 (for example, to apply signals to and receive signals from the CB 112). The test software 131 is created by the operational monitor database platform 103 for a particular CB 112 based on the system architect input received at the user interface 111. The test software 131 also records and analyzes data received from the test instruments 106. The test software 131 is designed so that the CB 112 can be tested in accordance with a particular test specification generated for that CB 112. Specifically, the test software 131 is designed to test the system formed from the CB hardware 117 configured with the CB software 116 on the CB 112. The CB hardware 117, the CB software 116 and the test software 131 each comprise one or more drivers 132 (implemented, for example, as system-level and/or application-level drivers). The drivers 132 are also generated by the operation monitor data platform 103 based on the system architecture. Each of the drivers 132 provide a software interface via which the test software 131 is able to communicate with the testing resources 105.

FIG. 2A is a block diagram of one embodiment of a development environment 200. FIG. 2B is a block diagram of one embodiment of a database 137 in the development environment 200 of FIG. 2A. The operational monitoring software 115 is created using the development environment 200 that is illustrated in FIGS. 2A and 2B. The test software 131 included in the operational monitoring software 115 comprises one or more component software items (CSI) 133 that are appropriate for the plurality of hardware components that comprise the CB hardware 117 for the target CB 112 (as identified by the I/P hardware model 249). The boot software 120 of the operational monitoring software 115 comprises one or more items of component software items (CSI) 123 for the plurality of hardware components that comprise the CB hardware 117. The boot software 120 also comprises a boot software manager 118 that carries out boot procedures appropriate for the target CB 112 (as specified by the system architecture input 109). The particular component software items 123 and 133 and the particular boot software manager 118 that are included in the operational monitoring software 115 for the target CB 112 are selected from the database 137 by the development software 204 and assembled into operational monitoring software 115.

The development environment 200 comprises a computer 202 (also referred to here as the “development computer” 202) on which development software 204 executes. The development software 204 causes the development computer 202 to perform at least a portion of the processing described here as being performed by the development computer 202. In the particular embodiment shown in FIG. 2A, the development computer 202 comprises at least one memory 252 and at least one programmable processor 250 that executes the development software 204. At least a portion of the development software 204 and any associated data structures are stored in memory 252 during execution. Also, in the particular embodiment shown in FIG. 2A, the development computer 202 comprises a storage medium 254 such (as a hard disk drive) on which the database 137 (described below) is stored. In this embodiment, the development software 204 is also stored on the storage medium 254 (though in other embodiments, the database 137 and the development software 204 (or a portion thereof) are stored on different media).

In the particular embodiment shown in FIG. 2A, the development software 204 comprises a generator user interface software 253 that interfaces with the user of the user interface 245 using appropriate input/output devices (not shown) such as a display device and keyboard and/or pointing device.

In the embodiment shown in FIG. 2A, a user is able to use the user interface 245 to input system architecture input 109 to the development computer 202 via the generator user interface software 253. The system architecture input 109 includes an input (I/P) software model 247, an input system model 248, and an input hardware model 249.

In the embodiment shown in FIG. 2A, the development software 204 is used in conjunction with the database 137 to generate the operational monitoring software 115 for the target CB specified in the system architecture input 109 in an automated manner using information stored in the database 137.

The database 137 includes libraries 170-172 in a data storage mechanism which stores the information used to generate the various operational monitoring software for a plurality of computers and computer board designs. In the embodiment shown in FIG. 2B, the database 137 stores information in a hardware module library 170. The hardware module library 170 includes information about a single device (also referred to here as “device information” 175 or “component software item” 175) in the single-device section 180 of the hardware module library 170. The hardware module library 170 includes information about the pairs or sets of interacting devices (also referred to here as “interacting device information” 176 or “interacting-component software item” 176) in the interacting-device section 181 of the hardware module library 170.

In the embodiment shown in FIG. 2B, the device information 175 comprises information about various signals that are used to communicate between devices on the CB 112. In the embodiment shown in FIG. 2B, the device information 175 additionally comprises information about various signals that are used to communicate between devices not on the CB 112 with which the device is capable of communicating.

In the embodiment shown in FIG. 2B, the device information 175 comprises an interconnect definition 222. In one embodiment, the interconnect definition 222 identifies, for a particular device, each signal that is supported by the one or more device interfaces 114 of the CB 112. The interconnect definition 222 also identifies, for each signal supported by the device interfaces 114, a signal type for that signal and the pin (or other terminal) of the respective CB interfaces 114. An exemplary device comprises a pin field that identifies the pin in the respective device interfaces 114 to which the signal associated with the entry is mapped, a signal name field that identifies a name for the associated signal, an I/O field that indicates whether the associated signal is an input, output, or both, and a signal type field that identifies a signal type for the associated signal.

In the embodiment shown in FIG. 2B, the device information 175 further comprises signal group information 218. In such an embodiment, the various device signals that are supported by a devices that are often found on a CB 112 are arranged into various groups (also referred to here as “signal groups”). Each group of device signals has an associated group type. Information about various group types (also referred to here as “group type information” 219) is stored in the database 137. The group type information 219, for each group type, identifies one or more logical signals for that group type and a signal type for each such logical signal. Each signal group is an instantiation of the group type associated with that signal group. The signal group information 218 for each signal group maps each logical signal defined for the associated group type to an appropriate device signal.

The device information 175 also comprises other information about a respective device (also referred to here as “other device information” 223). The other device information 223, includes for example, a name for the device, a description of the various connectors used to implement the device interfaces 114, or information about other functional attributes of the device (for example, particular functions that are and/or are not supported by the device) and/or physical attributes of the device (for example, the size and weight of the respective device). The device information 175 is stored in a hardware module library 170. One or more devices form a hardware module 170.

The software module library 171 includes software modules 177 that provide software for each of the ‘N’ devices in the single-device section 180 of the hardware module library 170. Specifically, the software modules 177 include operational software for each device, for booting each device and for testing each device in the single-device section 180. The software module library 171 also includes software modules 177 that provide software for each of the pairs or sets of interacting devices in the interacting-device section 181 of the hardware module library 170.

The system module library 172 includes system modules 178 that provide software for operating system of devices, for some or all of the systems that are able to be formed from the ‘N’ devices in the single-device section 180 of the hardware module library 170.

As groups of hardware modules are combined using various interconnections and various signal levels communicated over the interconnections, systems modules are formed. The database 137 includes a system module library 172 which houses system information for a plurality of system modules (also referred to here as “system module information” 178). The software executable to provided communication between devices, communication between devices and a system defined by a system module information 178, and communication between a first system defined by a first system module 178 and a second system is stored as interacting software modules 179 in the software module library 172.

The database 137 also stores one or more operational monitoring software templates 226. Each operational monitoring-platform template 226 identifies a particular type of a computer or computer board for which that template is suitable and, for example, identifies particular device-independent test and boot functions 233 that should be supported for that type of computer or computer board. The device-independent test and boot functions 233 comprise high-level component software items (CSI) 299. During the automated assembly of the operational monitoring software 115 for the target CB 112, a particular template 226 is selected and the device-independent test and boot functions 233 included in the selected template 226 are instantiated.

The database 137 also stores information about how the various signals are routed between an operational monitor platform 115 and a CB 112. This information is also referred to here as “signal flow information” 232. The signal flow information 232 maps each resource signal supported by a respective testing resource 105 to an input of the switch 108 and maps one or more device signals supported by the CB 112 to a particular output of the switch 108. The signal flow information 232 defines, for each such testing resource signal, the particular signal path from a respective testing resource interface 122 to the particular the switch interface 120 through any intermediate connectors or interfaces. The signal flow information 232 defines, for each such device signal, the particular signal path from a respective CB interface 114 to the particular switch interface 120 through any intermediate connectors or interfaces. In an exemplary signal flow information includes an input switch pin field that identifies the pin to which the input associated with that entry is mapped, a testing resource signal name field that identifies the resource signal mapped to the associated input, a testing resource field that identifies the testing resource 105 that supports the testing resource signal, testing resource interface pin field that identifies the pin of the respective testing resource interface 122 to which the associated testing resource signal is mapped, and a connector pin field that identifies a pin in a respective connector (that mates with the associated testing resource interface 122) to which the associated resource signal is mapped. The exemplary signal flow information also includes an output switch pin field that identifies the pin to which an output is mapped.

The test software 131 included in the operational monitoring software 115 comprises one or more component software items (CSI) 133 that are appropriate for the plurality of hardware components that comprise the CB hardware 117 for the target CB 112 (as identified by the I/P hardware model 249). The test software 131 is generated using the test procedure software (TPS) generation tool 206 and the test specification generation tool 205. The TPS generation tool 206 and the test specification generation tool 205 translate test procedures instantiated for the test specification of hardware components that comprise the CB hardware 117 into a plurality of CSI 133. In one embodiment, each CSI 133 is expressed in a suitable high-level testing language that is executed on the operational monitor database platform 103 in order to test a respective CB 112. The TPS generation tool 206 uses the signal flow information 232 and the driver information to add appropriate functionality to each CSI 133 that enables each mapped testing resource 105 to be communicatively coupled to an appropriate test point and to otherwise implement the operations specified in the respective test procedure (for example, by including functionality to invoke appropriate actions identified in the driver 132 information for each such mapped testing resource 105). The resulting test software 131 are ultimately installed on and executed by the operational monitor database platform 103 in order to test the current CB 112.

The boot software 120 included in the operational monitoring software 115 comprises one or more component software items (CSI) 123 that are appropriate for the target CB 112 (as identified by the I/P software model 247). The boot software 120 is generated using the boot generation tool 207 and boot specification generation tool 208. The boot generation tool 206 translates sets of boot procedures instantiated for the boot specification into respective CSI 123. In one embodiment, each CSI 123 is expressed in a suitable high-level testing language that is executed on the operational monitoring software 115 in order to boot the CB 112. The boot generation tool 207 uses the signal flow information 232 to add appropriate functionality to each CSI 123 that enables any mapped testing resource 105 to be communicatively coupled to an appropriate test point and to otherwise implement the operations specified in a required test procedure. The resulting CSI 123 are ultimately installed on and executed by the operational monitor database platform 103 in order to test the current CB 112.

Database generation is known in the art. For example, an exemplary database 137 is generated by identifying commonalities in known computer board system designs, designing and developing an initial database based on the identified commonalities, testing the initial database, sorting the initial database according to operations and interfaces between hardware components to form the software-component operational monitor database.

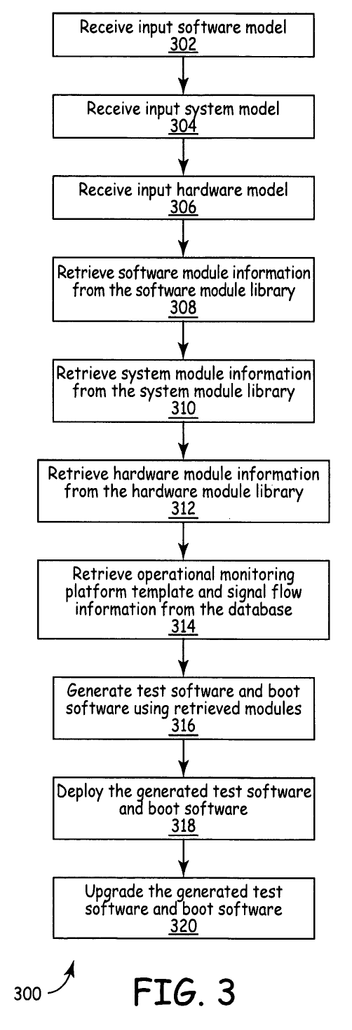

FIG. 3 is a flow diagram of one embodiment of a method 300 of generating a test specification in an automated manner. The embodiment of method 300 shown in FIG. 3 is described here as being implemented using the development environment 200 shown in FIG. 2A and the database 137 shown in FIG. 2B. In such an embodiment, method 300 is performed, at least in part, by the test specification generation tool 205 and is performed in order to generate a test specification for a particular CB 112 and operational monitor platform 115. The method 300 is performed, at least in part, by the TPS generation tool 206 and is performed in order to generate test procedures for a particular CB 112 and operational monitor platform 115. Likewise in such an embodiment, method 300 is performed, at least in part, by the boot specification generation tool 208 and is performed in order to generate a boot specification for a particular CB 112 and operational monitor platform 115. Likewise in such an embodiment, method 300 is performed, at least in part, by the boot generation tool 207 and is performed in order to generate boot programs for a particular CB 112 and operational monitor platform 115.

The input software model 247 is received (block 302), the input system model 248 is received (block 304) and the input hardware model 249 is received (block 306) at the development computer 202. The software model identifies software requirements of the system architecture, the hardware model identifies hardware requirements of the system architecture and the system model identifies the system requirements of the system architecture. The generator user interface software 253 in the development software 204 of the development computer 202 receives the models 247-249. The input software model 247, the input system model 248 and the input hardware model 249 together form the system architecture input 109 that defines the system architecture of the system on the CB 112. The input software model 247, the input system model 248 and the input hardware model 249 are entered in the development computer 202 through the user interface 245. In one implementation of the embodiment of method 300, the user interface 245 is a graphical user interface that was designed to receive the system architecture input 109 and input it to the development computer 202.

In one implementation, a user of the development software 204 uses software to prepare an electronic document (for example, a spreadsheet or a text document) that contains one or more needed items of information. For example, in one usage scenario, the user references appropriate requirements documents for the CB 112 (such as a software requirements specification, product requirements specification, and/or software maintenance manual) for such items. The electronic document is received by test specification generation tool 205 and the boot specification generation tool 208, which extract the needed items from the electronic document. In other implementations, at least some of the needed items are contained within a requirements documents and are tagged (or otherwise identified) in a manner that allows the needed items to be automatically extracted from such documents by the test specification generation tool 205 and the boot specification generation tool 208 (and/or by other extraction software). In other implementations, at least some of the needed items are manually input into the test specification generation tool 205 and the boot specification generation tool 208 by a user thereof (for example, by interacting with a graphical user interface that guides the user through the input process). In other embodiments, the needed items are received in other ways. The input hardware model 249 provides descriptions of the hardware components and the development software recognizes hardware components in the hardware model.

Method 300 further comprises retrieving from the database 137 software module information 177 from the software module library 171 for the current CB 112 (block 308), system module information 178 and/or 179 from the system module library 172 for the current CB 112 (block 310), device information 175 and/or interacting device information 176 from the hardware module library 170 for the current CB 112 (block 312), and operational monitoring templates 226 and signal flow information 232 for the current CB 112 (block 314).

Method 300 further comprises generating the test software 131, boot software 120 and the boot software manager 118 using the retrieved modules 177-179, the retrieved device information 175, the retrieved interacting device information 176, the retrieved operational monitoring software information 226 and signal flow information 232 (block 316). The modules 177-179, the device information 175, the interacting device information 176 are used by the development software 204 to generate the plurality of component software items 133 that form the test software 131 and the plurality of component software items 123 that form the boot software 120.

Method 300 further comprises deploying the generated test software 131 and boot software 120 to a CB 112 (block 318), wherein the access and usage of the test software 131 and boot software 120 assist in a build process of the CB 112. The build process of a CB 112 is performed by testing the hardware components 117 and the CB software 116 on prototype boards. In an exemplary build process, the testing results based on the deployment of the generated test software 131 and boot software 120 on the operational monitoring software 115 indicate the data rate capability of the CB hardware 117 is too slow, and a hardware component 117 is added or removed to modify the data rate of the CB 112. The deployment of the generated test software 131 and boot software 120 includes deploying the test software 131 and boot software 120 on the operational monitoring software 115 to the CB 112. The hardware components 117 are attached to the CB 112 according to the system architecture and the operational monitoring software is in electrical communication with the hardware components 117.

In one embodiment of FIG. 1, the operational monitor database platform 103 is included in the development computer 202 and software 128 in FIG. 1 includes the development software. In another implementation of this embodiment, the database 137 is not included in the operational monitor database platform 103 and the development computer 202 downloads the test software 131 and the boot software 120 to the operational monitor database platform 103 through the user interfaces 111. In all implementations of the method 300, the software 128 receives or generates the test software 131 and boot software 120 and inputs the test software 131 and boot software 120 through the interface 138 to the interconnect devices 110. The interconnect device inputs the test software 131 and boot software 120 to the CB 112 through the interfaces 114. In one implementation of method 300, the embodiment of the test software 131 and boot software 120 are input from interface 138 to the CB 112 through interfaces 114. The operational monitoring software is a programmable chip and the test software 131 and boot software 120 are programmed into the operational monitoring software 115.

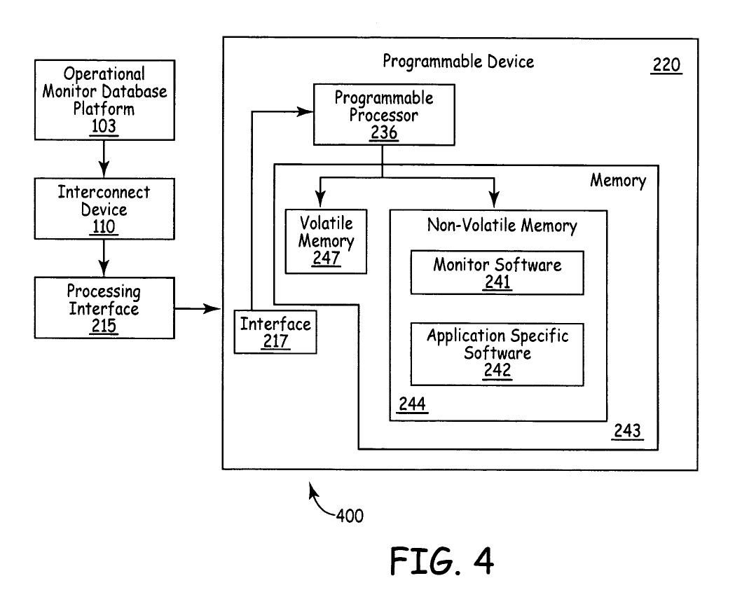

One implementation of an embodiment of block 318 is illustrated in FIG. 4. FIG. 4 is a block diagram of one embodiment of a deployment environment 400. The test software 131 and boot software 120 are deployed to a programmable device 220. The programmable device 220 is operable as the operational monitoring software 115 once test software 131 and boot software 120 are embedded in the programmable processor and stored in the memory 243. The operational monitoring database platform 103 which includes the test software 131 and boot software 120 in the software 128 (FIG. 1) inputs the test software 131 and boot software 120 to the interconnect device 110 which inputs the test software 131 and boot software 120 to a processing interface 215. In one implementation of the embodiment of FIG. 4, the processing interface 215 is one or more of the interfaces 114. The processing interface 215 inputs the test software 131 and boot software 120 to the interface (I/F) 217 located on the programmable device 220. A programmable processor 236 receives the test software 131 and boot software 120 and stores the test software 131 and boot software 120 in the memory 243 of the programmable device 220. The memory 243 includes a volatile memory 247 and a non-volatile memory 244. The non-volatile memory 244 includes monitor software 241 and application specific software 242.

When the generated test software 131 and boot software 120 are deployed the test software 131 and boot software 120 are activated by the operational monitoring software 115 to test the hardware components 117 and the CB software 116 on the CB 112.

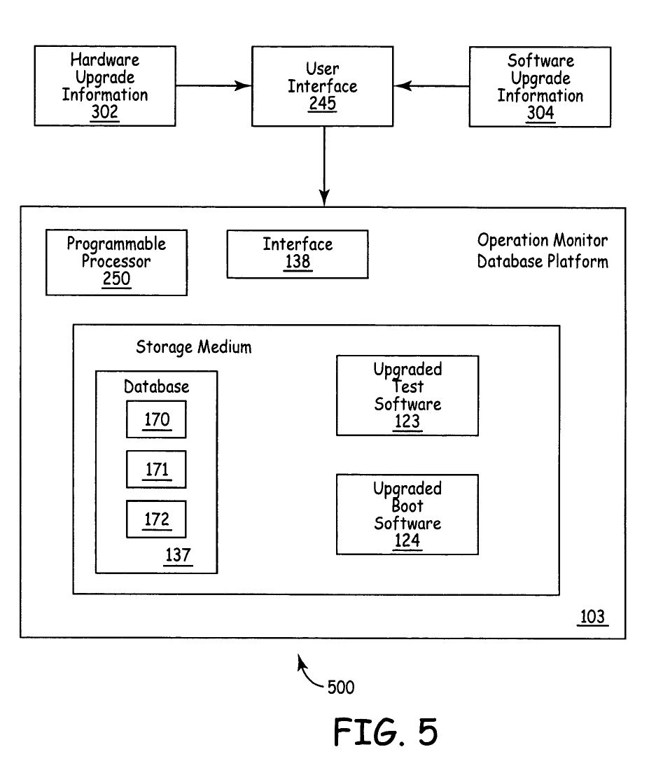

Method 300 further comprises upgrading the test software 131 and boot software 120 on the operational monitoring software 115 (block 320). One implementation of an embodiment of block 320 is illustrated in FIG. 5. FIG. 5 is a block diagram of one embodiment of an upgrade environment 500. The operational monitor database platform 103 receives hardware upgrade information 302 via user interface 245 and interface 138. The hardware upgrade information 302 comes from at least one hardware vendor. The operational monitor database platform 103 and modifies the test software to form upgraded test software 123 and modified the boot software to form upgraded boot software 121 as appropriate to accommodate the hardware upgrades. In this implementation of the embodiment of method 300, the hardware upgrade is deployed from the operational monitor database platform 103 to the operational monitoring software 115 on the CB 112. In another implementation of the embodiment of method 300, the hardware upgrade is programmable from the user interface 245 directly onto the operational monitoring software 115 on the CB 112. In yet another implementation of the embodiment of method 300, the hardware upgrade is requires a change out of a hardware component 117 on the CB 112.

In yet another embodiment of FIG. 1, the operational monitor database platform 103 receives software upgrade information 304 via user interface 245 and interface 138. The software upgrade information 304 comes from at least one software vendor. The operational monitor database platform 103 modifies the modifies the test software to form upgraded test software 123 and modifies the boot software to form upgraded boot software 121 as appropriate to accommodate the software upgrades. In this implementation of the embodiment of method 300, the software upgrade is deployed from the operational monitor database platform 103 to the operational monitoring software 115 on the CB 112. In another implementation of the embodiment of method 300, the software upgrade is programmable from the user interface 245 directly onto the operational monitoring software 115 on the CB 112.

In yet another embodiment of FIG. 1, the operational monitor database platform 103 receives hardware upgrade information 302 from at least one hardware vendor and software upgrade information 304 from at least one software vendor and modifies the test software to form upgraded test software 123 and modifies the boot software to form upgraded boot software 121 as appropriate to accommodate the hardware and software upgrades.

In any of these implementations of the embodiment of method 300, the operational monitoring software includes the upgraded test software 123 and upgraded boot software 121 after the received hardware upgrade information 302 and/or the received software upgrade information 304 are implemented by the development software 254.

Embodiments of the methods, systems, devices, and techniques described here provide a mechanism to generate a test specification and/or a test program set in an automated manner that enables various inputs to the process of generating a test specification and/or a test program set to be re-used. Such embodiments can reduce the amount of resources used to generate a test specification and/or a test program set for a computer board (for example, a computer, a mother board, and a computer board). This is especially desirable in those situations where the generation of a test specification, test program set and a boot program set are the most value-added services performed in the “production” or “service” phase of a given computer board's lifecycle.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### GLOSSARY

Software—A program or set of instructions that control the sequence of operations performed on a computer board or a programmable component on the computer board.

Boot Monitor—Operational software designed to initialize a processor-based computer board's hardware-specific components during power-up or reset and can reside on the computer board.

Operating System—Operational software that control the interfaces, transactions and execution between software programs and the hardware devices on a processor-based computer board.

Processor—The component(s) and/or device(s) on a computer board that control the execution of operational software's program instructions.

Database—An organized collection of stored information that is manageable and accessible within a computer.

Driver—Low-level software that provides and controls an interface to a specific component or interface on a computer board.

System Model—Defines the overall system controls, performance and responses expected from the interaction of internal hardware and software built into the system; Also identifies external system and test interfaces and the input and output specifications related to these interfaces.

Hardware Model—Defines hardware components and devices and their related revisions and corresponding specifications to be used within the system so that hardware components and devices meet the system model expectations. Also identifies test interfaces and test points available in the system.

Software Model—Defines the software inputs, processing, and expected outputs for system features and functions relative to the system and hardware models, inclusive of software test interfaces necessary.

What is claimed is:

1. A method of testing a system architecture within a computer board, the method comprising:
receiving an input software model, an input system model and an input hardware model at a development computer, wherein the software model identifies software requirements of the system architecture, the hardware model identifies hardware requirements of the system architecture and the system model identifies the system requirements of the system architecture;
retrieving software module information from a software module library in a record;
retrieving system module information from a system module library in a database;
retrieving hardware module information from a hardware module library in the database;
generating test software and boot software using the retrieved software module information, the retrieved system module information and the retrieved hardware module information; and
deploying the generated test software and the generated boot software to a computer board, wherein the access and usage of the test software and boot software assist in a build process of the computer board, wherein hardware components are attached to the computer board according the system architecture, and wherein an operational monitoring software that includes the test software and the boot software is in electrical communication with the hardware system.

2. The method of claim 1, the method further comprising:
retrieving monitoring platform information and signal flow information from the database.

3. The method of claim 2, the method further comprising:
expanding the database by storing one or more of operational monitoring systems created by the operational monitor database platform in an operational monitoring-platform information of the database.

4. The method of claim 2, the method further comprising:
activating the deployed test software and the deployed boot software, wherein the operational monitoring software boots at least one of the hardware components and tests at least one of the hardware components on the computer board.

5. The method of claim 1, the method further comprising:
activating the deployed test software and boot software, wherein the operational monitoring software boots at least one of the hardware components and tests at least one of the hardware components on the computer board.

6. The method of claim 1, wherein generating test software and boot software comprises:
generating a test specification from a test specification generating tool;
generating a test program set from a test program set generation tool;
generating a boot specification from a boot specification generating tool; and
generating a boot program set from a boot program set generation tool, wherein in the test software comprises a library of component software items for the plurality of hardware components that populate the computer board, and wherein the boot software comprises a library of component software items including software that is implemented by the boot software manager.

7. The method of claim 1, the method further comprising:
upgrading the test software and the boot software.

8. A system for building a system architecture on a computer board, the system comprising:
means for creating an operational monitoring software including test software and boot software;
means for interfacing an operational monitor database platform to a computer board implementing hardware and software;
means for deploying the operational monitoring software to the computer board from the operational monitor database platform; and
means for testing the computer board by activating the test software.

9. The system of claim 8, the system further comprising:
means for booting the computer board by activating the boot software.

10. Development software comprising program instructions embodied on a computer-readable medium that, when executed by a development computer, are operable to cause the development computer to:
receive an input software model, an input system model and an input hardware model at a development computer, wherein the software model identifies software requirements of the system architecture, the hardware model identifies hardware requirements of the system architecture and the system model identifies the system requirements of the system architecture;
retrieve software module information from a software module library in a database;
retrieve system module information from a system module library in the database;
retrieve hardware module information from a hardware module library in the database;
generate test software and boot software using the retrieved software module information, the retrieved system module information and the retrieved hardware module information; and
deploy the generated test software and the generated boot software to a computer board.

11. The development software of claim 10, operable to further cause the development computer to:
retrieve monitoring platform information and signal flow information from the database.

12. The development software of claim 11, operable to further cause the development computer to:
activate the deployed test software and boot software, wherein the operational monitoring software boots at least one of hardware components and tests at least one of the hardware components on the computer board.

13. The development software of claim 10; operable to further cause the development computer to:
activate the deployed test software and boot software, wherein the operational monitoring software boots at least one of hardware components and tests at least one of the hardware components on the computer board.

14. The development software of claim 10, operable to further cause the development computer to:
generate a test specification from a test specification generating tool;
generate a test program set from a test program set generation tool;
generate a boot specification from a boot specification generating tool; and
generate a boot program set from a boot program set generation tool, wherein in the test software comprises a library of component software items for the plurality of hardware components that comprise the computer board hardware, and wherein the boot software comprises a library of component software items including software that is implemented by the boot software manager.

15. The development software of claim 10, operable to further cause the development computer to:
expand the database by storing one or more operational monitoring systems created by the operational monitor database platform as other operational monitoring software information in the operational monitoring-platform information of the database.

16. The development software of claim 10, operable to further cause the development computer to:
upgrade the test software and the boot software.

17. A system comprising:
a development computer; and
a database communicatively coupled to the development computer;
wherein the development computer is operable to:
receive an input software model, an input system model and an input hardware model, wherein the software model identifies software requirements of a system architecture, the hardware model identifies hardware requirements of the system architecture and the system model identifies the system requirements of the system architecture;
retrieve software module information from a software module library in a database;
retrieve system module information from a system module library in the database;
retrieve hardware module information from a hardware module library in the database;
generate test software and boot software using the retrieved software module information, the retrieved system module information and the retrieved hardware module information; and
deploy the generated test software and the generated boot software to a computer board, wherein the access and usage of the test software and boot software assist in a build process of the computer board.

18. The system of claim 17, wherein the database is stored on at least one of a storage medium local to the development computer and a file server.
